(19) United States
(12) Patent Application Publication
(10) Pub. No.: US 2012/0207085 A1
(43) Pub. Date: Aug. 16, 2012

(54) TRANSMISSION FOR A WIRELESS NETWORK AND CORRESPONDING RECEPTION METHOD

(75) Inventors: Charline Guguen, Cesson Sevigne Cedex (FR); Samuel Guillouard, Chantepie (FR); Patrick Fontaine, Cesson Sevigne Cedex (FR)

(73) Assignee: THOMSON LICENSING

(21) Appl. No.: 13/380,788

(22) PCT Filed: Jun. 21, 2010
(86) PCT No.: PCT/EP10/58721

§ 371 Date: May 3, 2012

(30) Foreign Application Priority Data
Jun. 24, 2009 (FR) 0954298

(51) Int. Cl. H04W 56/00; H04W 88/04

(52) U.S. Cl. 370/324

(57) ABSTRACT

The invention relates to an emission method for a wireless network comprising a plurality of stations emitting at the same frequency. In order to optimize the use of radio channels, the method comprises the following steps implemented by at least one relay station RS of the plurality of stations:
reception via a first wireless channel of a first signal (512) representative of data (503), and
emission via a second wireless channel of a second signal (514) representative of the same received data (503) to an assembly comprising at least one receiver,
the second signal being emitted synchronously with a third signal (504) representative of the same data (503) and intended to be emitted by at least one base station BS1 of the plurality of stations.

The invention also relates to the corresponding reception method.

### 1. SCOPE OF THE INVENTION

The invention relates to the domain of telecommunications and more specifically to the wireless transmission and reception of data, in a system comprising more than one station broadcasting data in a synchronous manner and at the same frequency.

### 2. PRIOR ART

According to the prior art, a wireless mobile network, for example of type GSM (Global System, for Mobile communication) WiMAX (based on the standard IEEE 802.16) or LTE (Long Term Evolution), of the 3GPP (3^{rd} Generation Partnership Project) project, has cells each containing a base station, a cell being defined by the area covered by the transmission of the base station. To ensure the total coverage of a cell, it is sometimes necessary to associate one or more relay stations with the base station of a cell to relay the signals emitted by the base station in areas not covered by the base station, these areas constituting the shadow zones of the cell. Such relay stations therefore have the role of retransmitting signals emitted by the base station to the mobile terminals present for example in the shadow zones of the cell in down-link and also to retransmit signals emitted by the mobile terminals present in the shadow zones of the cell to the base station. The base stations of a network are generally connected to a wired or wireless backbone (for example by satellite link) whereas a relay station associated with a base station is not connected to the backbone but only to the base station or stations with which it is associated by a wireless link.

The use of relay stations in a covered cell poses many problems, for example since the relay stations use, for the retransmission of the signals, radio channels different from those used by the base stations, in particular in order to minimize interference. The multiplication of the radio channels used by the base station on the one hand and by the relay station on the other hand makes the network management more difficult, in particular when the number of mobile terminals is high. Moreover, the use of different radio channels obliges a mobile terminal changing from a zone covered by the base station to a shadow zone not covered (or partly covered) by the base station but covered by the relay station to perform a handover operation which may result in service interruptions at the mobile terminal level,

### 3. SUMMARY OF THE INVENTION

The purpose of the invention is to overcome these disadvantages of the prior art.

More particularly, the purpose of the invention in particular is to optimize the use of the radio channels in a wireless network implementing at least one relay station.

The invention relates to a transmission method for a wireless network, the network comprising a plurality of stations emitting at the same frequency. The method comprises the following steps implemented by at least one relay station of the plurality of stations:
reception via a first wireless channel of a first signal representative of data, and
transmission via a second wireless channel of a second signal representative of the received data to a set comprising at least one receiver,
the second signal being transmitted synchronously with a third signal representative of the data and intended to be transmitted by at least one base station of the plurality of stations,

According to a particular characteristic, said first signal and said third signal are transmitted by at least the same base station,

Advantageously, the method comprises a step for the reception of at least one signal representative of synchronization information.

According to another characteristic, the at least one signal representative of the synchronization information is transmitted by the at least one station having transmitted the first signal.

Advantageously, the first signal is transmitted over a first time slot, the second and third signals are transmitted over a second time slot, the first and second time slots belonging to a same communication frame.

According to a particular characteristic, the first signal is transmitted over a first time slot, the second and third signals are transmitted over a second time slot, the first and second time slots belonging to two consecutive communication frames.

According to another characteristic, the at least one relay station receives the first signal via at least a first antenna and transmits the second signal via at least a second antenna.

Advantageously, the same fourth signal is transmitted by the at least one base station and by the at least one relay station synchronously.

The invention also relates to a transmission method for a wireless network, the network comprising a plurality of stations emitting at the same frequency, the method comprising the following steps implemented by at least one base station of the plurality of stations:
transmission via a first wireless channel of a first signal representative of data over a first time slot, and
transmission via a second wireless channel of a third signal representative of data over a second time slot,
the third signal being transmitted synchronously with a second signal representative of the data and intended to be transmitted by at least one relay station of the plurality of stations recipient of the first emitted signal.

The invention also relates to a reception method for a wireless network, the network comprising a plurality of stations transmitting at the same frequency and at least one mobile terminal, the method comprising the following steps implemented by the at least one mobile terminal;
reception via a first wireless channel of a first signal representative of data over a first time slot, and
reception of a combined signal over a second time slot, the combined signal comprising a second signal representative of the data and a third signal representative of the data,
the second and third signals being transmitted synchronously by respectively at least one base station and at least one relay station of the plurality of stations.

According to a particular characteristic, the reception method comprises a step for the selection of the received signals according to at least a selection criterion belonging to the group comprising;
a received signal power,
a link quality between at least one transmitting station and the receiver,
a received signal error rate,

Advantageously, the method comprises a gain adaptation step according to a parameter belonging to the group comprising:
a received signal position in a communication frame,
information representative of the transmitter of a signal,

### 4. LIST OF FIGURES

The invention will be better understood, and other specific features and advantages will emerge upon reading the following description, the description making reference to the annexed drawings wherein:

FIG. 1 shows a wireless system 1 implementing several base stations, a relay station and a mobile terminal, according to a particular embodiment of the invention,

FIGS. 2 and 3 diagrammatically show respectively a (base or relay) station and a mobile terminal of the system 1 or 4, according to a particular embodiment of the invention,

FIG. 4 shows a wireless system 4 implementing a base station, a relay station and several mobile terminals, according to a particular embodiment of the invention,

FIGS. 5a to 5c diagrammatically show the structure of a communication frame at the level of respectively a base station, a relay station and a mobile terminal of the system 1, according to a first particular embodiment of the invention,

FIGS. 6a to 6c diagrammatically show the structure of communication frames at the level of respectively a base station, a relay station and a mobile terminal of the system 1, according to a second particular embodiment of the invention,

FIGS. 7a to 7e diagrammatically show the structure of communication frames at the level of respectively a base station, a relay station and each of the mobile terminals of the system 4, according to a particular embodiment of the invention,

FIG. 8 shows a transmission method according to a particular embodiment of the invention, implemented by a relay station of the system 1 or 4,

FIG. 9 shows a transmission method according to a particular embodiment of the invention, implemented by a base station of the system 1 or 4, and

FIG. 10 shows a reception method according to a particular embodiment of the invention, implemented by a mobile terminal of the system 1 or 4.

### 5. DETAILED DESCRIPTION OF EMBODIMENTS OF THE INVENTION

The invention will be described in reference to a particular embodiment of a transmission method in a wireless network comprising at least a base station, at least a relay station and at least a mobile terminal, the base and relay stations transmitting at the same frequency. A first signal is transmitted by at least one base station to at least one relay, station by using a first physical channel, the first transmitted signal being representative of data intended for at least one mobile terminal. Once the first signal is received, the at least one relay station transmits over a second physical channel a second signal representative of the same data as those of the first signal. A third signal is transmitted synchronously upon the transmission of the second signal over the same second physical channel as that used for the transmission of the second signal, the third signal being also representative of the same data as the first signal and the second signal. The transmission of the second and third signals over the same physical channel enables the use of channels to be optimized in a system implementing a relay station while improving the data reception at the level of the at least mobile terminal, several transmitters transmitting synchronously signals representative of the same data.

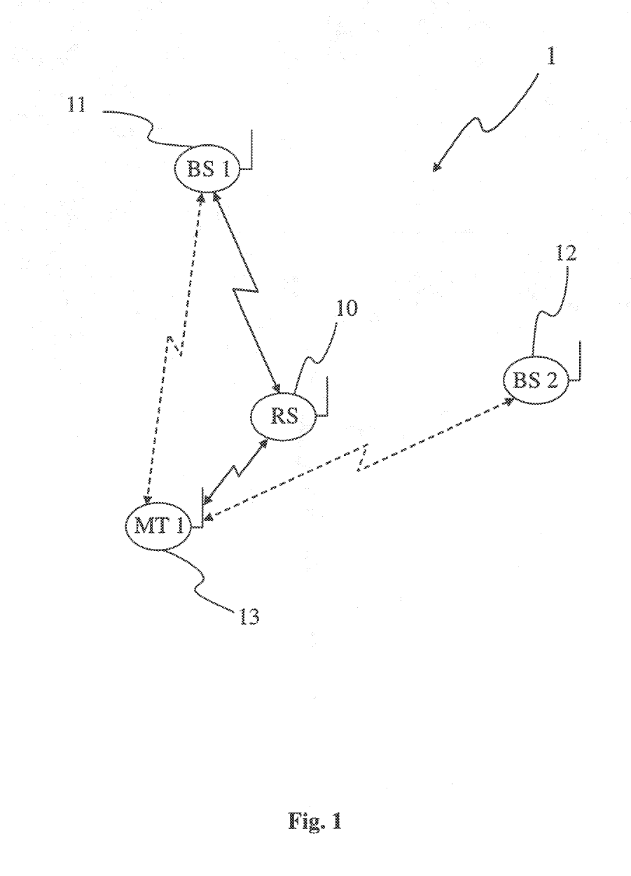

FIG. 1 shows a wireless communication system 1 implementing several base stations 11, 12, a relay station 10 and a mobile terminal 13, according to a particular embodiment of the invention. All the stations of the system 1, i.e. the base stations 11 and 12 and the relay station 10, transmit at a single frequency, i.e. the stations operate over a single frequency (Le. with a negligible frequency deviation with respect to the OFDM system considered, typically lower than 1 Hz for a system of the DVB-T (“Digital Video Broadcasting—Terrestrial”) type. The transmission at a single frequency by the set of stations of the network enables dispensing with any “handover” mechanism at the level of the mobile terminal. The base station BS1 11 transmits a first signal to the relay station RS 10 by using a first physical channel. Once the first signal is received by the relay station 10, the relay station transmits in its turn a second signal representative of the data contained in the first signal intended for the mobile terminal MT1 13 by using a second physical channel. Advantageously, the base station BS1 11 transmits a third signal representative of the same data as those contained in the first signal intended for the mobile terminal 13 synchronously with the transmission of the second signal by also using the second physical channel, The second and third signals are therefore transmitted over the same physical channel synchronously (i.e. with a negligible temporal deviation (for example less than 1 μs) and without temporal sliding of a signal transmitted by a base station with respect to another signal transmitted by another base station). Generally, a physical channel is characterized by a frequency band and a time slot. In the particular case of a CDMA (“Code Division Multiple Access”) access, a physical channel is also characterized by a spreading code. The wireless links between BS1 11 and RS 10 on the one hand and between RS 10 and MT1 13 on the other hand are shown by solid line bidirectional arrows on FIG. 1. As for it, the wireless link between BS1 11 and MT1 13 is shown by a dotted line bidirectional arrow. The base stations BS1 11 and BS2 12 are advantageously connected to a “backbone” by a link of the wired or wireless type (for example, by a satellite or radio link) not represented on FIG. 1.

According to one variant, the third signal is transmitted by the base station BS2 12 synchronously with the transmission of the second signal by using the second physical channel, and not by the base station BS1 11. The wireless link between BS2 12 and MT1 13 is shown by a dotted line bidirectional arrow. The third signal is representative of the data transmitted by BS1 in the first signal, this data being transmitted to BS2 for example by a server of the backbone connecting the base stations BS1 and BS2 to each other.

According to another variant, the first signal is transmitted synchronously and at the same frequency by the base stations BS1 11 and BS2 12 to RS 10, by using the same first physical channel. The third signal is then advantageously transmitted synchronously at the same frequency by BS1 11 and BS2 12 by using the second physical channel. The base stations BS1 11 and BS2 12 thus form a synchronized network transmitting to the relay station 10 and/or to the mobile terminal 13 the same contents at the same frequency, i.e. the base stations operate over a single frequency (i.e. with a negligible frequency deviation with respect to the OFDM system considered (typically lower than 1 Hz for a system of the DVB-T type)) synchronously (i.e. with a negligible temporal deviation (for example less than 1 μs) and without temporal sliding of a signal transmitted by a base station with respect to another signal transmitted by another base station), the transmission frequency being synchronized on the various base stations 11 and 12, for example by the reception of a reference frequency given by an external element (for example, by GPS (Global Positioning System) satellite or by terrestrial station for broadcasting a reference frequency or hour). The base stations 11 and 12 are advantageously of the SISO (‘Single Input Single Output’) type and only have a single antenna. According to one variant, the base stations 11 and 12 are of MIMO type and each have a MIMO coder and several antennas transmitting a MIMO signal. According to another variant, some of the base stations 11 and 12 of the system 1 are of SISO type and some are of MIMO type. According to this variant, the base stations also form a synchronized network transmitting a same content intended for a relay station and/or a given mobile terminal at a same frequency. According to another implementation example, the base stations 11 and 12 form a cooperative MIMO system in which the base stations possess indifferently one or more antennas. Such a cooperative MIMO system uses antennas distributed over several base stations, i.e. the signal transmitted is distributed spatially between several antennas that can belong to several base stations of a same sub-set. The complete signal, with all the spatial streams, is combined in the air to be received by the relay station 10 and/or the mobile terminal 13 to which are assigned the base stations of the considered sub-set. The base stations of such a cooperative MIMO system also form a synchronized network transmitting a same content to the relay station and/or for the considered mobile terminal at a same frequency. According to another variant, some base stations of the system 1 are of MIMO type, cooperative or not, and the others are of SISO type.

The mobile terminal 13 is able to receive and to decode the signals transmitted by the stations 10 to 12 and the stations 10 to 12 are able to receive and to decode the signals transmitted by the mobile terminal 13. The relay station 10 is also able to receive and to decode the signals transmitted by the base stations 11 and 12 and the base stations 11 and 12 are able to receive and to decode the signals transmitted by the relay station 10.

Advantageously, the mobile terminal 10 of the system 1 is a portable device, for example a portable telephone or terminal adapted to receive and process broadcast services (for example voice or audio data restitution and/or video data display, or more generally restitution, storage or processing of multimedia data),

Advantageously, the stations 10 to 12 of the system 1 are fixed devices. The stations 10 to 12 are high power transmitters adapted to broadcast data over a wide coverage area or average or low power transmitters adapted to broadcast data over a more restricted coverage area. According to one variant, one at least of the stations 10 to 12, for example the relay station 10, forms a system covering a ‘picocell’, i.e. a small area, such as the interior of a budding, a supermarket, a station, that is to say having a range of a few ten or so metres (according to some embodiments, in a picocell, the range is advantageously less than 300 m). According to another variant, at least one of the stations 10 to 12, for example relay station 10, forms a system designed to cover a “femtocell” that is to say an area restricted of smaller size than a picocell, such as a few rooms of a house or building, one floor of a building, a plane, that is to say having a range of a few metres (according to some embodiments, in a femtocell the range is advantageously less than 100 metres).

Advantageously, the relay station 10 is of the SISO type and has a single antenna. According to one variant, the relay station 10 is of the MIMO type and has several antennas.

Advantageously, the mobile terminal 13 is of the SISO type and has a single antenna. According to one variant, the mobile terminal 13 is of the MIMO type and has several antennas.

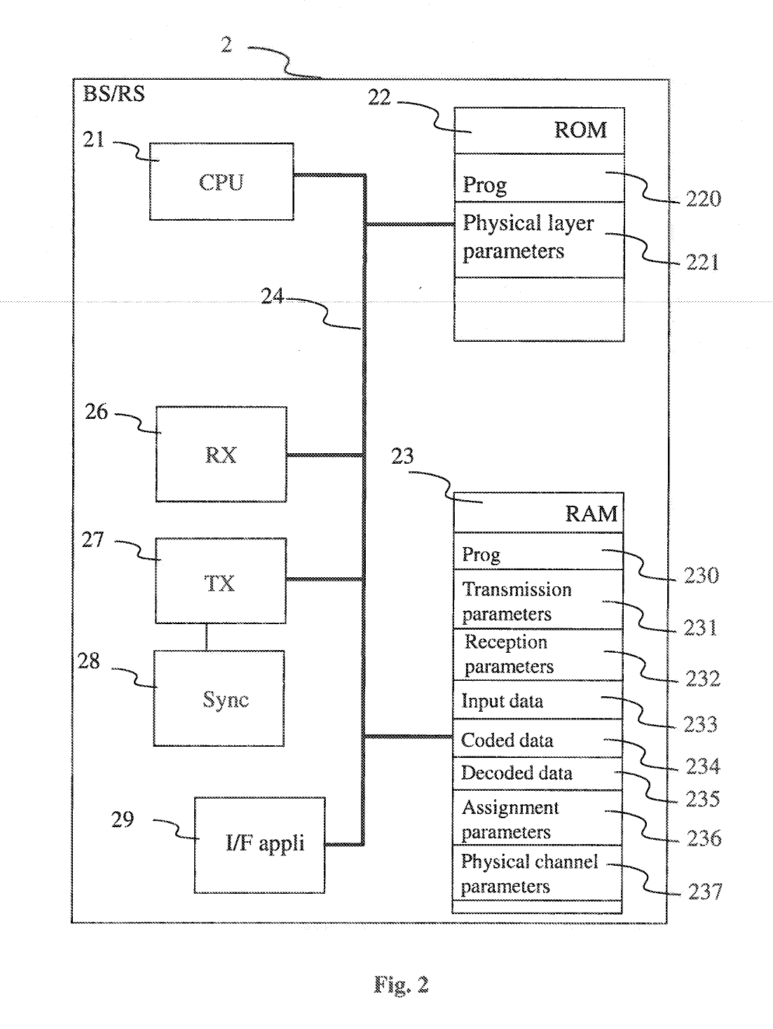

FIG. 2 shows diagrammatically a hardware embodiment of a station 2 corresponding for example to the base stations 11 and 12 and to the relay station 10 of FIG. 1.

The base station 2 comprises the following elements, connected to each other by a bus 24 of addresses and data that also transports a clock signal:
a microprocessor 21 (or CPU),
a non-volatile memory of the ROM (“Read Only Memory”) type 22,
a random access memory or RAM 23,
a radio interface 26,
an interface 27 suitable for the transmission of data (for example broadcasting of services or multipoint to point or point to point transmission) and notably performing the functions of a coder and/or ODM modulators,
an interface 28 suitable for receiving a synchronisation signal and for synchronising the interface 27, and/or
an MMI (Man Machine Interface) interface 29 or a specific application adapted for the display of information for a user and/or the input of data or parameters (for example, the parameterization of sub-carriers and data to be transmitted).

It is noted that the word “register” used in the description of the memories 22 and 23 designates, in each of the memories mentioned, a memory zone of low capacity (some binary data) as well as a memory zone of large capacity (enabling a whole programme to be stored or all or pad of the data representative of data received or to be broadcast).

The memory ROM 22 comprises in particular:
a ‘prog’ 220 program, and
parameters 221 of physical layers.

The algorithms implementing the steps of the method specific to the invention and described below are stored in the ROM memory 22 associated with the station 2 implementing these steps. When powered up, the microprocessor 21 loads and runs the instructions of these algorithms.

The random access memory 23 comprises in particular:
in a register 230, the operating program of the microprocessor 21 responsible for switching on the base station 2,
transmission parameters 231 (for example, modulation, coding, MIMO, frame recurrence parameters),
reception parameters 232 (for example, modulation, coding, MIMO, frame recurrence parameters), incoming data 233,
coded data 234 for data transmission;
decoded data 235 formatted to be transmitted to the interface to the application 29,
assignment parameters 236 of the station to one or more mobile terminals (for example the number of assigned mobile terminals, the maximum number of base stations assigned, the quality of the link between a base station and the assigned mobile terminal, the efficiency in bit rate of the base stations, the localization of a mobile terminal); and
parameters of the physical channel 237 (for example the assigning of determined time slots, of a code determined and/or intervals of sub-carriers determined upon transmission of the data by the station 2).

The radio interface 26 is adapted for the reception of signals broadcast if necessary by the mobile terminals 13 of the system 1. In the case where the station 2 corresponds to a base station 11, 12, the radio interface 26 is suitable for the reception of signals transmitted if necessary by the relay station 10 of the system 1. In the case where the station 2 corresponds to the relay station 10 of the system 1, the radio interface 26 is suitable for the reception of signals transmitted if necessary by at least one of the base stations 11 and 12 of the system 1.

FIG. 3 diagrammatically shows a hardware embodiment of a mobile terminal 3 belonging to the system 1, corresponding for example to the mobile terminal 13 and adapted to receive and decode the signals transmitted by the station 2.

The mobile terminal 3 comprises the following elements, connected to each other by a bus 34 of addresses and data that also transports a clock signal:
a microprocessor 31 (or CPU),
a non-volatile memory of the ROM (“Read Only Memory”) type 32,
a random access memory or RAM 33,
a radio interface 36, and
an interface 37 suitable for the transmission of data, and
an MMI interface 39 adapted for the display of information for a user and/or the input of data or parameters (for example, parameterization of sub-carriers and transmitted data).

It is noted that the word “register” used in the description of the memories 32 and 33 designates, in each of the memories mentioned, a memory zone of low capacity as well as a memory zone of large capacity (enabling a whole programme to be stored or all or part of the data representative of sets of data received or decoded).

The memory ROM 32 comprises in particular;
a ‘prog’ 320 program, and
parameters 321 of physical layers

The algorithms implementing the steps of the method specific to the invention and described below are stored in the ROM 32 memory associated with the mobile terminal 3 implementing these steps. When powered up, the microprocessor 31 loads and runs the instructions of these algorithms.

The random access memory 33 comprises in particular:
in a register 330, the operating programme of the microprocessor 31 responsible for switching on the terminal 3, reception parameters 331 (for example, modulation, coding, MIMO, frame recurrence parameters),
transmission parameters 332 (for example, modulation, coding, MIMO, frame recurrence parameters),
incoming data 333 corresponding to the data received and decoded by the receiver 36,
coded data 334 for data transmission,
decoded data 335 formatted to be transmitted to the interface to the application 39,
received signal selection parameters 236 (for example, power of the received signal, quality of the link between a station 2 and the mobile terminal 3, received signal error rate), and
gain adaptation parameters 237 (for example, position of a received signal in a communication frame, information representative of the station 2 transmitting the signal).

The radio interface 36 is adapted for the reception of signals broadcast by the stations 10 to 12 of the system 1.

Other structures of the station 2 and/or of the mobile terminal 3 than those described with respect to the FIGS. 2 and 3 are compatible with the invention. In particular, according to variants, stations and/or mobile terminals compatible with the invention are implemented according to a purely hardware embodiment, for example in the form of a dedicated component (for example, in an ASIC or FPGA or VLSI) (respectively, ‘Application Specific Integrated Circuit’, ‘Field Programmable Gate Array’, ‘Very Large Scale Integration’) or of several electronic components integrated into a device or in the form of a mixture of hardware elements and software elements

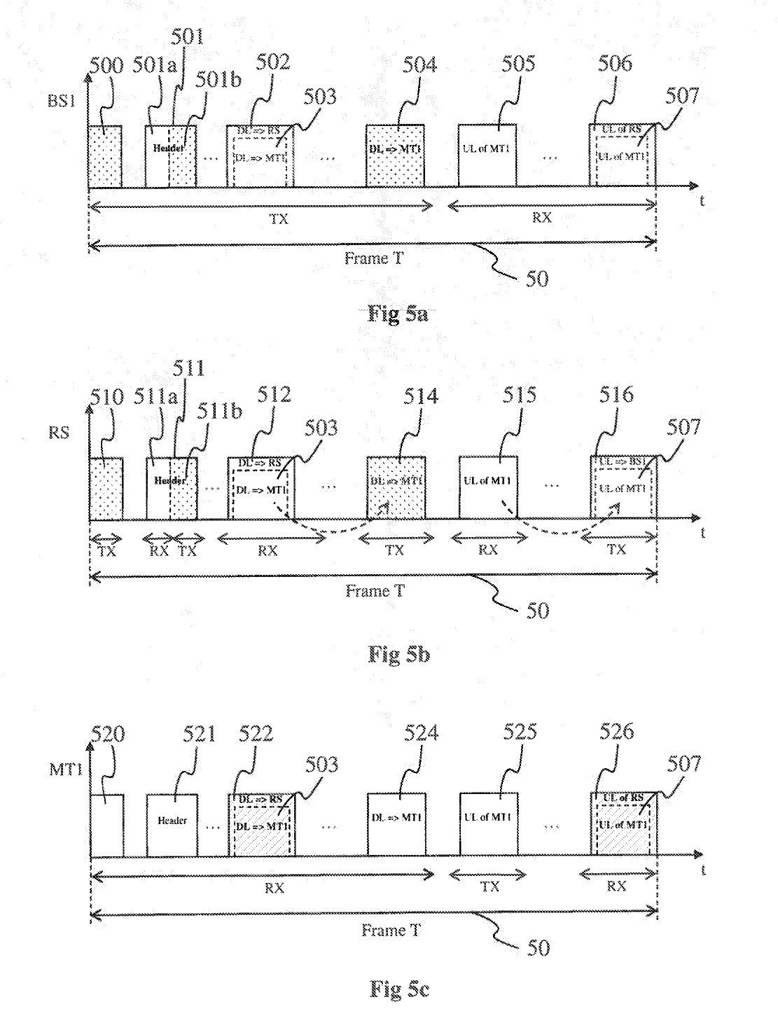

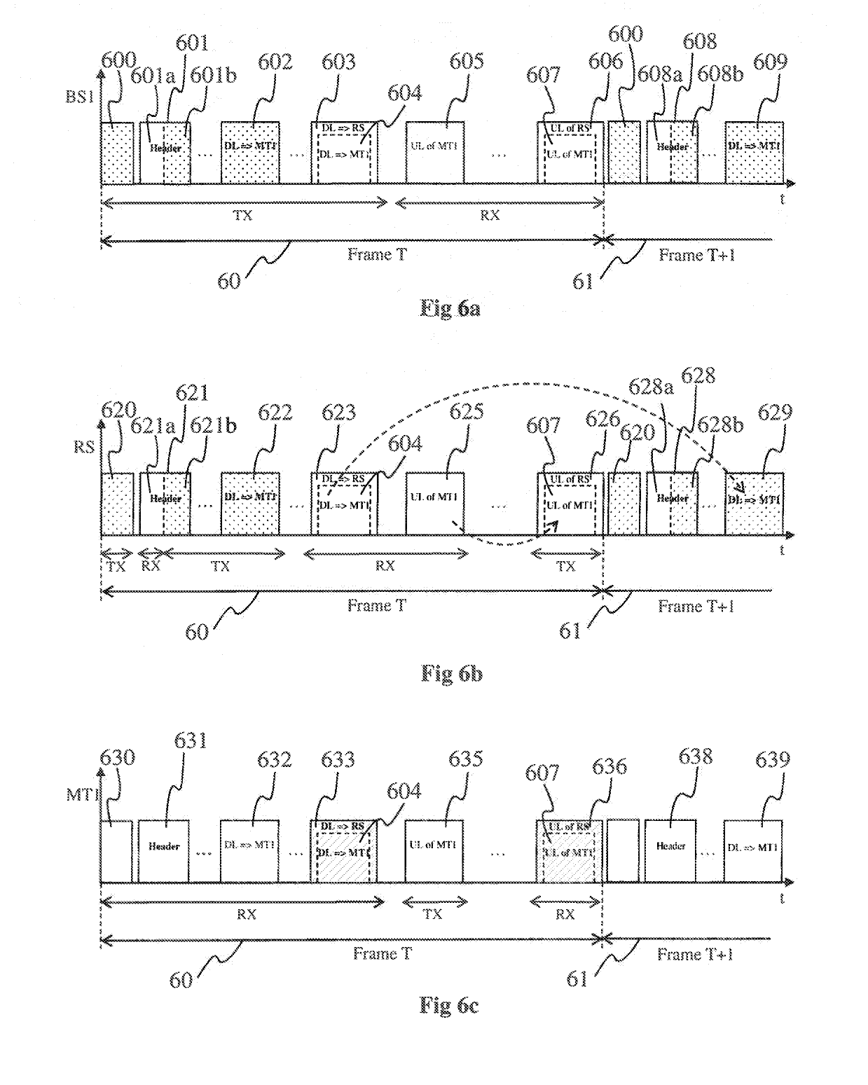

FIGS. 5a to 6c respectively show the structure of a communication frame representative of the exchanges of bursts at the level of the base station BS1 11 of the relay station RS 10 and of the mobile terminal 13 of the system 1 of FIG. 1, according to a first particularly advantageous non-restrictive implementation example of the invention.

FIG. 5a shows a communication frame T 50 representing the burst exchanges between the base station BS1, the relay station RS and the mobile terminal MT1, seen from BS1. The frame 50 comprises a burst 500 corresponding for example to a synchronization preamble, a burst BS1 transmitted by BS1 corresponding for example to a frame header, a burst 502 transmitted by BS1 in downlink DL to RIS, a burst 504 transmitted by BS1 in downlink DL to MT1, a burst 505 received from MT1 in uplink UL and a frame 506 received from RS in uplink UL. The burst 601 advantageously comprises a first part of frame header 501a and a second part of frame header 501b, The first header part 501a comprises information representative of the structure of the frame 50, i.e. for example a description of the sequence of time slots DL and UL composing frame 50. Such a description comprises for example information representative of the start and finish times of each time slot, of frame duration, of the downlink (DL) or uplink (UL) character of the slots, of the sub-carriers allocated for the communication of each of the bursts associated with each of the slots in the case of OFDMA (Orthogonal Frequency-Division Multiple Access) modulation of the spread spectrum code used in the case of CDMA (Code Division Multiple Access) modulation of the recipient of each time slot (or burst) of the transmitter of each time slot. The first header part 501a is transmitted by BS1 over a physical channel characterized by a group of parameters comprising a list of sub-carriers, a time slot, an interference level and, in the case of CDMA access, the same spread code. The second header part 501b comprises information representative of the sequence of slots (or bursts) transmitted by the base station BS1 and the relay station RS synchronously over the same physical channel, i.e. slots 504 and 514 according to the example shown by FIGS. 5a and 5b. The second header part 501b is transmitted synchronously with the second header part 511b by BS1 and RS over the same physical channel. The two second header parts 501b and 511b comprise the same information representative of the sequence of the slots transmitted by BS1 and RS synchronously. The physical channel used for the transmission of the first header part 501a is advantageously different from the physical channel used by BS1 and RS for the synchronized transmission of the second header parts 501b and 511b in that it uses a different time slot, i.e. that the first header part is transmitted over at least a first time slot and the second header part is transmitted over at least a second time slot different from the first time slot The burst 502 corresponds to a first signal transmitted by BS1 to RS, representative of data 503, data 503 which is intended to be retransmitted by RS to MT1 once the data 503 is received and decoded by RS The burst 502 is transmitted over a physical channel, known as first physical channel. The burst 504 is transmitted synchronously with the burst 514 transmitted by RS over the same physical channel, known as second physical channel. The burst 504 corresponds to, a signal (known as third signal) transmitted by BS1 to MT1, representative of the data 503 contained in the first signal. The burst 514 corresponds to a signal (known as second signal) transmitted by RS to MT1, representative of the data 503 contained in the first and third signals. The second and third signals are transmitted synchronously by respectively RS and 851 and are representative of the same data intended for MT1. The first and second physical channels are advantageously different in that they use different time slots. The burst 505 corresponds to a signal, transmitted by MT1 in uplink UL to RS, representative of data intended for the base station network. This burst 505 is advantageously received and decoded by BS1. According to one variant, the burst 505 is received by BS1 without being decoded by BS1. According to another variant, the burst 505 is not received by BS1. The burst 506 corresponds to a signal transmitted by RS to BS1 and received by BS1, representative of data 507 identical to those contained in the signal transmitted by MT1 corresponding to the burst 505, received or not by BS1.

FIG. 5b shows the communication frame T 50 seen from RS. The frame 50 comprises a burst 510 corresponding for example to the synchronization preamble, a burst 511 corresponding for example to the frame header, a burst 512 received by RS, a burst 514 transmitted by RS to MT1, a burst 515 received from MT1 and a burst 516 transmitted by RS to BS1. The burst 510 is transmitted synchronously by RS with the burst 500 transmitted by BS1. The bursts 500 and 510 correspond to signals representative of the same synchronization information transmitted to all the mobile terminals of the network. Advantageously, the synchronization information is transmitted for the first time (in a first frame) by BS1 to RS before being retransmitted by BS1 and RS synchronously in the frames following the first frame. According to one variant, information to update this synchronization information is transmitted for example by BS1 to RS every X frames, X being for example equal to 5, 10 or 20. According to one variant, the synchronization information is given to BS1 and RS by an external element (for example, by GPS satellite or by terrestrial broadcast station of a reference time). The frame header 511 comprises a first header part 511a received from BS1 and comprising information representative of the sequence of the bursts (or time slots) of the frame 50, this information being transmitted by BS1 in the burst 501a. The frame header 511 also comprises a second header part 511b comprising information representative of the sequence of the slots transmitted by BS1 and RS synchronously (504 and 514), this information being also contained in the burst 501b transmitted synchronously by BS1 with the burst 511b. The burst 512 is received from BS1 and comprises information representative of data 503 intended for MT1. RS decodes the data 503 to transmit them during a subsequent burst of the frame T 50, namely burst 514. The burst 514 corresponds to a signal (known as second signal) transmitted by RS representative of the data 503 received by RS with the reception of burst 512. The burst 514 is transmitted synchronously with the burst 504 transmitted by BS1, the burst 514 corresponding to a second signal representative of the data 503 and the burst 504 corresponding to a third signal representative of the same data 503 or 503. The two bursts 504 and 514 are transmitted over the same physical channel. The burst 515 is received and corresponds to a signal transmitted by MT1. RS receives the burst 515 and decodes the data comprised in the burst 515 to transmit them in a subsequent burst of the same frame T 50, namely burst 516. The data thus received in the burst 515 are coded once again to be inserted into a burst 516 corresponding to a signal transmitted by RS and intended for BS1.

FIG. 5c shows the communication frame T 50 seen from MT1, The frame comprises a burst 520 comprising synchronization information received from BS1 and/or RS, a burst 521 corresponding for example to a frame header, a burst 522 corresponding to a signal representative of data 503, a burst 524 corresponding to a signal representative of the same data 503, a burst 525 transmitted by MT1 and a burst 526 comprising data 507. The burst 520 corresponds to a signal received by MT1 corresponding to a combination of signals transmitted synchronously by BS1 and RS, namely the combination of a signal transmitted by BS1 corresponding to the burst 500 and of a signal transmitted by RS corresponding to the burst 510. According to one variant, the signal received by MT1 corresponds to either signal transmitted by respectively BS1 and RS. The header 521 received by MT1 also comprises two parts, the first one being transmitted by 631 and the second one being transmitted synchronously by BS1 and RS Advantageously, MTT1 only decodes the second part of the header 521, only the second part being necessary to MT1. Indeed, the second header part comprises information describing the time slots 524 and 525 concerning MT1. The burst 522 corresponds to a signal received from BS1 representative of data 503, the signal transmitted by BS1 and containing the data 503, being intended for RS Advantageously, this burst 522 is not decoded by MT1 (burst hatched on FIG. 5c). According to one variant, the burst 522 is not received by MT1, for example if 631 is too far or if MT1 is in a non-covered area of the emission area of BS1 or if this burst is described in the first header part 501a, in the case where this first header part would not be correctly received. According to another variant, MT1 receives and decodes the burst 522 to extract the data 503 from it, by example if the received signal corresponding to the burst 522 is received at a satisfactory power level (for example, with a power level greater than −80 dBm). The burst 524 corresponds to a signal received by MT1 corresponding to a combination of signals transmitted synchronously by BS1 and RS, namely the combination of a signal transmitted by BS1 corresponding to the burst 504 and of a signal transmitted by RS corresponding to the burst 514. The received signal 524 is representative of the data 503, According to one variant, the signal received by MT1 corresponds to either signal 504 or 514 transmitted by respectively BS1 and RS. MT1 then decodes the received signal 524 to extract from it the data 503 intended for it. The burst 525 corresponds to a signal transmitted by MT1 to RS so that RS retransmits the data contained in the signal transmitted by MTT1 to BS1. The burst 526 corresponds to the signal received or not by MT1, transmitted by RS to BS1 and representative of the data 507 transmitted by MT1 with the burst 525. This burst 526, in hatched lines on FIG. 5c, is not used by MT1.

FIGS. 6a to 6c respectively show the structure of communication frames representative of burst exchanges at the level of the base station BS1 11, of the relay station RS 10 and of the mobile terminal 13 of the system 1 of FIG. 1, according to a second non-restrictive particularly advantageous embodiment of the invention.

FIG. 6a shows a communication frame T 60 and a part of a communication frame T+1 61 representing the burst exchanges between the base station BS1, the relay station RS and the mobile terminal MT1, seen from BS1. The bursts 600, 601, 605, 607 are identical to respectively the bursts 500, 501, 505, 506 described for FIG. 5a and are not described again in detail here. Likewise, the burst 608 is identical to the burst 601. The bursts appearing with a background composed of points correspond to the bursts transmitted synchronously by BS1 and RS. The burst 602 is transmitted by BS1 synchronously with the burst 622 transmitted by RS. These two bursts correspond to two signals respectively transmitted by BS1 and RS by using the same physical channel representative of the same data intended for MT1. The burst 603 corresponds to a signal transmitted by BS1 and intended for RS, representative of data 604 intended to be transmitted again by RS in a subsequent burst and by BS1 in the frame T+1 61 during the burst 609. Likewise, the data transmitted during the burst 602 have been transmitted by BS1 during the frame T−1 (not represented) in a burst intended for RS.

FIG. 6b shows a communication frame T 60 and a part of a communication frame T+1 61 seen from RS. The bursts 620, 621, 625, 627 are identical to respectively the bursts 510, 511, 515, 516 described for FIG. 5b and are not described again in detail here. Likewise, the burst 628 is identical to the burst 621. The bursts appearing with a background composed of points correspond to the bursts transmitted synchronously by BS1 and RS, The burst 622 is transmitted by RS synchronously with the burst 602 transmitted by BS1. The burst 623 corresponds to a signal received from BS1 representative of data 624 intended for MT1. RS thus decodes the data 624 to code them again, for example with a new code, to transmit them with the burst 629 of the frame T+1 61. The burst 609 is transmitted by BS synchronously with the burst 629 transmitted by RS. These two bursts correspond to respectively two signals, transmitted respectively by BS1 and RS by using the same physical channel, representative of the same data 604 intended for MT1.

FIG. 6c shows a communication frame T 60 and a part of a communication frame T+1 61 seen from MT1. The bursts 630, 631, 635 and 636 are identical to respectively the bursts 520, 621, 525, 526 described for FIG. 5c and are not described again in detail here. Likewise, the burst 633 is identical to the burst 631. The bursts appearing with a hatched background correspond to the bursts not used by MT1 advantageously. The burst 632 corresponds to a signal received by MT1 corresponding to a combination of signals transmitted synchronously by BS1 and RS, namely the combination of a signal transmitted by BS1 corresponding to the burst 602 and of a signal transmitted by RS corresponding to the burst 622. According to one variant, the signal received by MT1 corresponds to either signal 602 or 612 transmitted by respectively BS1 and RS. MT1 then decodes the received signal 632 to extract from it the data intended for it. The burst 633 corresponds to a signal received from BS1 representative of data 604, the signal transmitted by BS1 and containing the data 503 being intended for RS Advantageously, this burst 633 is not decoded by MT1. According to one variant, the burst 633 is not received by MT1, for example if BS1 is too far or if MT1 is in a non-covered area of the emission zone of BS1. According to another variant, MT1 receives and decodes the burst 633 to extract the data 604 from it, by example if the received signal corresponding to the burst 633 is received at a satisfactory power level. The burst 639 of the frame T+1 61 corresponds to a signal received by MT1 corresponding to a combination of signals transmitted synchronously by BS1 and RS, namely the combination of a signal transmitted by BS1 corresponding to the burst 609 and of a signal transmitted by RS corresponding to the burst 619. According to one variant, the signal received by MT1 corresponds to either signal 609 or 619 transmitted by respectively 651 and RS. MT1 then advantageously decodes the received signal 639 to extract from it the data 604 intended for it. In the case where MT1 has decoded the signal 633 representative of the data 604 transmitted by BS1, MT1 then advantageously does not decode the signal 639, the data 604 having been received and decoded. According to one variant, and even if the data 604 have already been received and decoded by decoding the signal 633, MT1 decodes the signal 639 to extract the data from it, to verify by comparison with the data 604 received with the burst 633 contain no error. In the case where MT1 has decoded the signal 633 to extract from it the data 604 and the data have been decoded with errors or partly, MT1 then decodes the signal 639 to extract from it the data 604 and correct or complete, the set of data 604 already received.

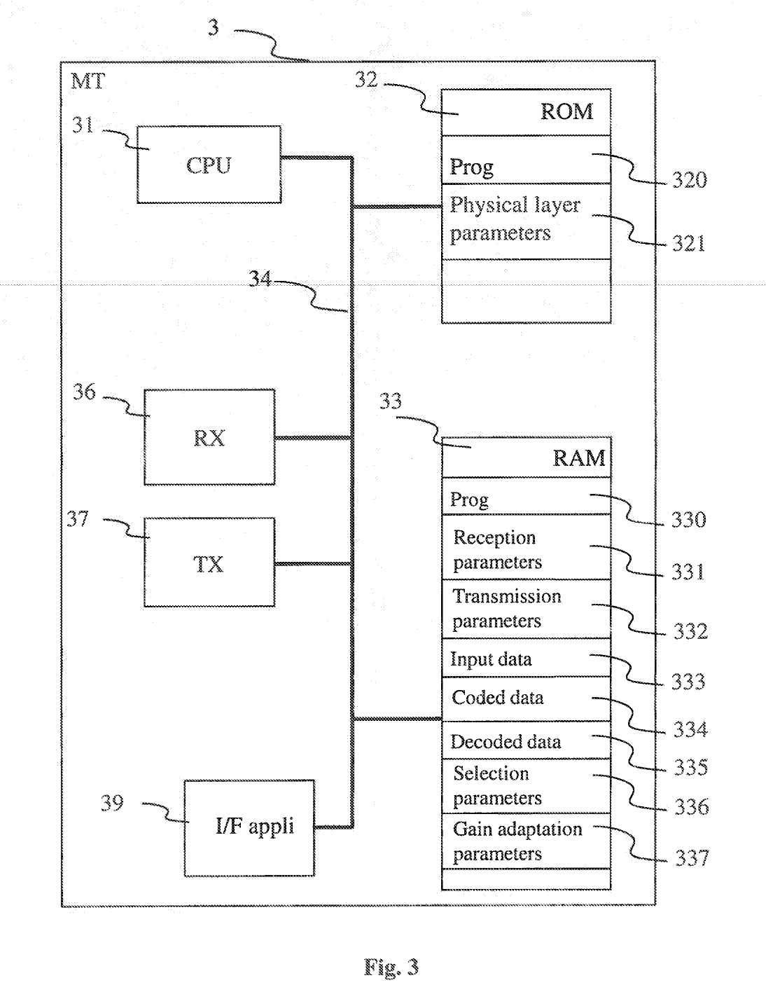

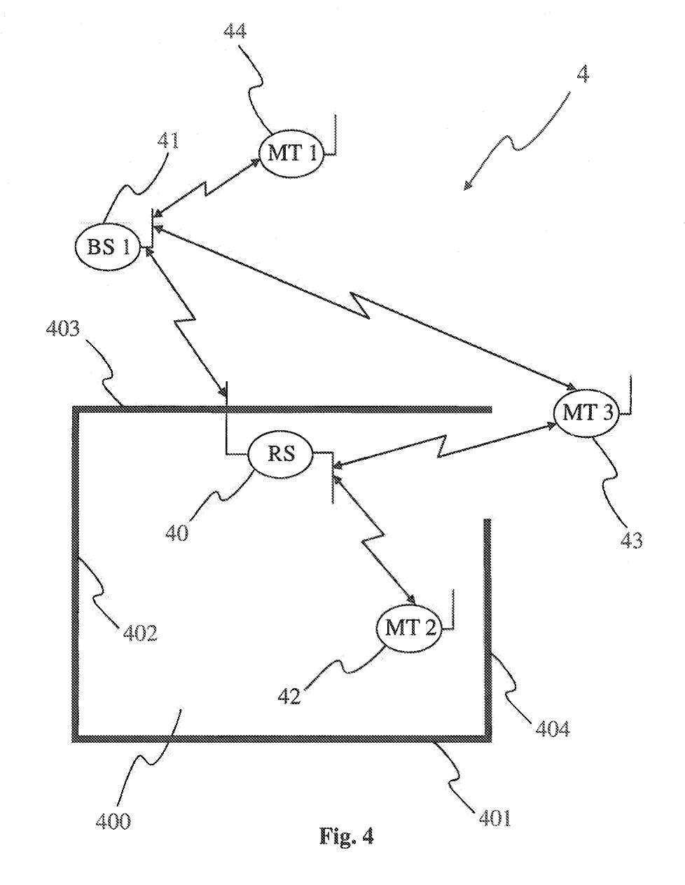

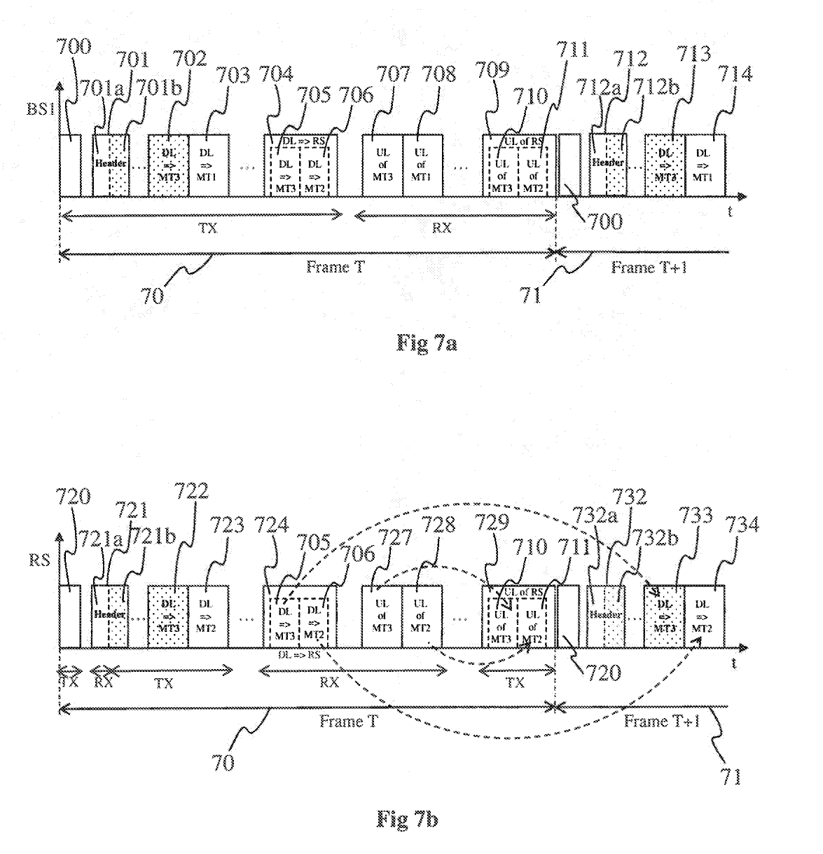

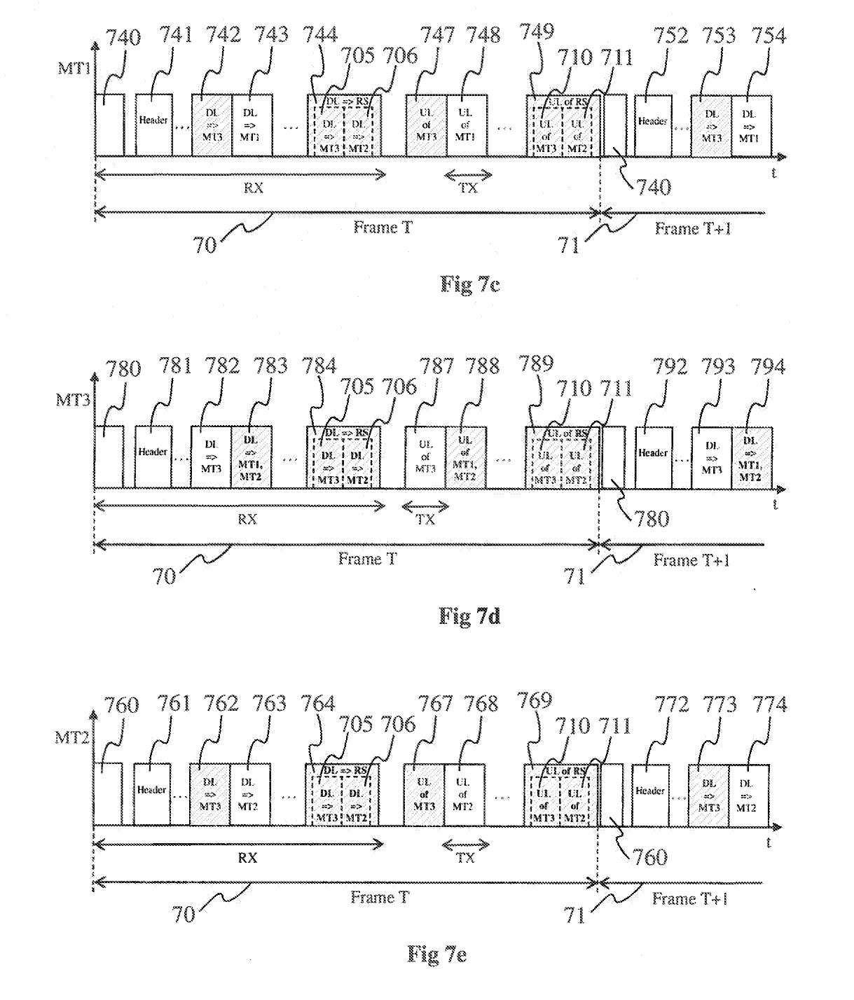

FIG. 4 shows a wireless communication system 4 implementing a base station BS1 41, a relay station RS 40 and several mobile terminals 42, 43 and 44, according to a particular embodiment of the invention. AD the stations of the system 4, i.e. BS1 41 and RS 40 transmit at a single frequency, i.e. the stations operate over a single frequency (i.e. with a negligible frequency deviation with respect to the OFDM system considered, typically lower than 1 Hz for a system of the DVB-T (‘Digital Video Broadcasting—Terrestrial’) type. The relay station RS 40 is located in an interior space 400 surrounded with walls 401 to 404, the wall 404 being partly open. The space 400 corresponds for example to the inside of a building or of a house or to the inside of a room of a building or of a house. The base station BS1 41 is located outside of the space 400. The mobile terminal MT1 44 is located close to BS1 outside of the space 400. The mobile terminal MT2 42 is located inside the space 400. The mobile terminal MT3 43 is located outside of the space 400, close to the opening of the wall 404 and in direct line of sight of BS1. BS1 and RS are separated by the wall 403 which does not let through the signals transmitted by either station intended for the other station or which at least very highly attenuates the transmitted signals. The relay station RS 40 advantageously comprises two antennas, one for the exchange of signals with BS1 and the other for the exchange of signals with the terminals located inside the space 400 (MT2 42) or in direct line of sight, for example MT3 43. On its side, BS1 communicates with MT1 44 and MT3 43 on the one hand and with RS 40 on the other hand but does not directly communicate with MT2 42 which is located inside the space 400, therefore separated from BS1 41 by at least a wall 403. MT 1 44 is assigned to BS1 only for the exchange of signals and MT2 42 is assigned to RS 40 only for the exchange of signals. The signals transmitted by BS1 do not interfere with the signals transmitted by RS via its indoor antenna, i.e. the antenna allocated to the exchange of signals with the terminals located in the space 400. The communications between BS1 and MT1, on the one hand, and the communications between RS and MT2, on the other hand can therefore take place simultaneously without interference risks. In addition, and in particular owing to the walls surrounding the space 400, there is no (or very little) interference between the signals transmitted from BS1 to MT1, on the one hand, and the signals transmitted from RS to MT2, on the other hand. As will be detailed in respect of FIGS. 7a to 7e, BS1 and RS can advantageously use the same physical channel to communicate respectively with MT1 and MT2, i.e. by using the same frequency and the same time slot in particular. The number of physical channels used is thus reduced and therefore optimized. When BS1 wants to transmit data to MT2, BS1 transmits a signal representative of the data intended for MT2 to RS over a given, physical channel. For the reception of this signal, RS selects the antenna dedicated to communications from the outside of the space 400. Once the received signal is decoded by RS 40, RS 40 switches over to its antenna allocated to communications with the terminals inside the space 400 (or in direct line of sight of RS) and transmits a signal representative of the data intended for MT2 42 to MT2 by using another physical channel as that used by BS1 to transmit the data to RS The physical channels used are different in that they use different time slots. Concerning the communications with MT3, the process is equivalent to that described in respect of FIG. 1. To transmit data to MT3, BS1 advantageously transmits a first signal representative of the data to be transmitted to RS 40 by using a first physical channel. The signal thus transmitted by BS1 is received by RS on its antenna allocated to communications with the stations located outside of the space 400. Once the first signal is received and decoded by RS. RS switches over to its second antenna to transmit a second signal representative of the data received from BS1 to MT3 by using a second physical channel different from the first physical channel. As RS and BS1 transmit data at the same frequency, the second physical channel is different from the first physical channel in that it uses a time slot different from that used by the first physical channel. BS1 also transmits a third signal representative of the same data intended for MT3 by using the same second physical channel, i.e. synchronously with the emission of the second signal. The signal then received by MT3 is a combined signal corresponding to the combination of the second and of the third signal. According to one variant, the second signal is emitted with a spread code different from that used for the emission of the third signal (use of a CDMA access (‘Code Division Multiple Access’). According to this variant, the second and third signals then no longer use the same second physical channel, the second and third signals being however always emitted at the same frequency and synchronously.

In UL (‘uplink’), i.e. from a mobile terminal MT1, MT2, MT3 to a station RS, BS1, MT3 43 directly communicates with BS1 41, MT2 42 communicates with BS1 41 by means of RS 40, MT3 43 communicates with BS1 41 directly or by means of RS 40. In the case of MT2 for example, MT2 emits a signal to RS over a given physical channel, the signal being representative of data intended for BS1. This signal is received by RS on its ‘indoor’ antenna, i.e. the antenna allocated in particular to communications with the mobile terminals located in the space 400. Once the signal is decoded, RS emits a signal to BS1 over another physical channel than that used for the communication between MT and RS, the signal being representative of the data intended for BS1 and received from MT2 by RS. This last signal is emitted by RS by using its ‘outdoor’ antenna, i.e. the antenna allocated in particular to communications with BS1 located outside of the space 400.

According to one variant, BS1 is associated with at least another base station to form a first set of base stations. This first set of base stations is for example allocated for the communication with MT1. The base stations of this first set then emit data intended for MT1 by advantageously using the same physical channel, the data being emitted by each base station of the set synchronously. This same first set or a second set formed for example by a part of the base stations of the first set is allocated for the transmission of data to MT2 and/or MT3. Each base station of the second set emits a signal to RS representative of the same data intended for MT2. Each base station emits synchronously at the same frequency and the signal received by RS corresponds to the combination of the signals emitted by the base stations of the second set. Likewise, a plurality of relay stations can be used to form a set of relay stations in communication with the set(s) of base stations, on the one hand, and the mobile terminals, on the other hand. The use of several base stations instead of a single one and/or the use of several relay stations instead of a single one enables lesser power stations to be implemented while keeping a good link quality between transmitter and receiver, the same data being emitted synchronously by several stations.

FIGS. 7a to 7e respectively show the structure of communication frames representative of burst exchanges at the level of the base station BS1 41, of the relay station RS 40 and of each mobile terminal MT1 44, MT2, 42 and MT3 43 of the system 4 of FIG. 4, according to a non-restrictive particularly advantageous embodiment of the invention.

FIG. 7a shows a communication frame T 70 and a part of a communication frame T+1 71 representing the burst exchanges between the base station BS1, the relay station RS and the mobile terminal MT1, seen from BS1 The frame T 70 comprises a first burst 700 corresponding for example to a synchronization preamble and a burst 701 corresponding for example to a frame header comprising two header parts 701a and 701b. The frame T+1 comprises similar bursts, respectively 700 and 712. These bursts have been described in more detail with respect to FIGS. 5a to 5c and must be likened respectively to bursts 500 and 501. They will not be further described hereafter. The frame T also comprises a burst 702 intended for MT3, a burst 703 intended for MT1, a burst 704 intended for RS, a burst 708 received from MT3, a burst 708 received from MT1 and a burst 709 received from RS. The burst 703 corresponds to a signal emitted by BS1 representative of data intended for MT3. This burst is emitted synchronously with the burst 722 emitted by RS the burst 722 corresponding to a signal representative of the same data as those contained in the burst 702. The data comprised in the bursts 702, 722 have been emitted for the first time by BS1 in a frame T−1 immediately preceding the frame Tin a burst to RS. The burst 703 corresponds to a signal emitted by BS1 to MT1 and representative of data intended for MT1. The burst 704 emitted by BS1 corresponds to a signal intended for RS, this signal being representative of data intended for MT3, on the one hand, and of data intended for MT2, on the other hand. The data intended for MT3 comprised in this burst 704 will be emitted again for BS1 in the burst 713 of the frame T+1 71. The burst 707 corresponds to a signal emitted by MT3 representative of data 710 intended for BS1. This burst 707 is received or not by BS1 according for example to the power of the received signal and/or the quality of the link between MT3 and BS1. If the burst 707 is effectively received by BS1, BS1 decodes or not the signal according to the power of the received signal, to the quality of the link between MT3 and BS1 and/or to the error rate of the received signal. The burst 708 corresponds to a signal emitted by MT1 representative of data intended for BS1. This burst 708 is received then decoded by 1351. The burst 709 corresponds to a signal emitted by RS representative of data 710 emitted by MT3 and intended for 1351 and representative of data 711 emitted by MT2 and intended for 1351. This burst 709 is decoded by BS1 to extract from it the data 710 and/or 711. According to one variant, if BS1 has already fully decoded and without error the data 710 during the reception of the burst 707, BS1 decides to only decode the signal 709 in part to extract from it only the data 711 from MT2.

FIG. 7b shows a communication frame T 70 and a part of a communication frame T+1 71 representing the burst exchanges between the base station 1351, the relay station RS and the mobile terminal MT1 to MT3, seen from RS. The frame T 70 comprises a first burst 720 corresponding for example to a synchronization preamble and a burst 721 corresponding for example to a frame header comprising two header parts 721a and 721b. The frame T+1 comprises similar bursts, respectively 720 and 732. These bursts have been described more in detail with respect to FIGS. 5a to 5c and must be likened respectively to the bursts 510 and 511. They will not be further described hereafter. The burst 722 corresponds to a signal emitted by RS synchronously with the signal 702 emitted by BS11, the two signals being emitted by using the same physical channel, being intended for MT3 and representative of data intended for MT3. The burst 723 corresponds to a signal emitted by MT2 representative of data intended for MT2 and emitted by BS1 in a burst of a frame T−1 preceding the frame T and not represented on FIG. 7b. The burst 723 is emitted by RS over the same time slot as the burst 703 emitted by BS1 to MT1. Indeed, and such as described on FIG. 4, the emissions of BS1 to the mobile terminals located outside of the space 400 do not interfere with the emissions of RS to the mobile terminals located inside the space 400, owing to the walls 401 to 404 which surround the space 400. Therefore, the time slot used by BS1 to emit a signal to MT1 can be reused by RS to emit a signal to MT2, the physical channel used by BS1 and RS then being advantageously the same. According to one variant, the physical channels used by BS1 and RS to emit respectively to MT1 and MT2 during the same time slot are different in that they use different spread codes in the case of a CDMA access. The burst 724 received from BS1 corresponds to a first signal emitted by BS1 representative of data 706 intended for MT3 and of data 706 intended for MT2. Once the data are decoded by RS, RS emits in its turn these data 705 and 705 during two bursts, respectively 733 to MT3 and 734 to MT2, of the frame T+1 71 following the frame T 70. The burst 733 thus corresponds to a second signal emitted by RS to MT3 and representative of the data 705 received by RS in the burst 724 and intended for MT3. This burst 733 is emitted synchronously with the burst 713 which corresponds to a third signal emitted by BS1 and representative of the same data 705 intended for MT3. The signal 724 is advantageously received by RS over a first physical channel and the signals 713 and 733 are advantageously emitted by respectively BS1 and RS over a second physical channel. The first physical channel is different from the second physical channel in that it uses a time slot different from that used by the second channel. The burst 734 corresponds to a signal emitted by RS to MT2 and representative of the received data 706. The burst 734 uses the same time slot as the burst 714 emitted by BS1 to MT1, no interference appearing between these bursts, BS1 and RS being separated by a wall 403. The use of the same time slot for the simultaneous emission of two signals by two different stations to two different mobile terminals enables the use of the, bandwidth to be optimized. Lastly, the bursts 727 and 728 correspond respectively to a signal emitted by MT3 to RS and to a signal emitted by MT2 to RS The signal emitted by MT3 is representative of data 710 intended for BS1 and the signal emitted by MT2 is representative of data 711 intended for BS1. Once these data are decoded by RS, these data 710 and 711 are re-emitted by RS in a burst 729 corresponding to a signal intended for BS1.

FIGS. 7c to 7e show a communication frame T 70 and a part of a communication frame T+1 71 seen respectively from MT1, MT3 and MT2. The bursts appearing with a hatched background correspond to the bursts not decoded by respectively MT1, MT3 and MT2 advantageously. The bursts 740, 780 and 760 corresponding to synchronization preambles are not detailed here, just as the headers 741, 752, 781, 792, 761 and 772. The burst 742, received or not by MT1 and intended for MT3, is not decoded by MT1, just as the bursts 744 intended for RS, 747 intended for RS, 749 intended for BS1 and 753 intended for MT3. Only the bursts 743 which are intended for it are decoded by MT1. The burst 748 is emitted by MT1 and is directly intended for BS1.

The burst 782 corresponds to a signal intended for MT3 and representative of data intended for MT3. This received signal corresponds to the combination of the signals 702 and 722 emitted respectively by BS1 and RS. The burst 783, received or not by MT3 and intended for MT1 and/or MT2, is not decoded by MT3, just as the bursts 784 intended for RS, 788 intended for BS1 and/or RS, 789 intended for BS1 and 794 intended for MT1 and/or MT2. The burst 787 is emitted by MT3 and is intended for RS and BS1. The burst 793, corresponding to a signal emitted by RS and BS1 and representative of the data 705 is received and decoded by MT3. According to one variant, the burst 784 is decoded at least partly to extract from it the data 705 intended for MT3, for example if the power level of the received signal is greater than a threshold value and/or if it is received without error. According to this variant and if the data 705 have indeed been decoded, the burst 793 is not used by MT3, the data that it contains having already been received and decoded.

The burst 763 corresponds to a signal received from RS and intended for MT2 and representative of data intended for MT2. The burst 762, received or not by MT2 and intended for MT3, is not decoded by MT2. just as the bursts 764 intended for RS, 767 intended for RS/BS1, 769 intended for BS1 and 773 intended for MT3. The burst 768 is emitted by MT2 and is intended for RS. The burst 774, corresponding to a signal emitted by RS and representative of the data 706 is received and decoded by MT2. According to one variant, the burst 764 is decoded at least partly to extract from it the data 706 intended for MT2, for example if the power level of the received signal is greater than a threshold value and/or if it is received without error. According to this variant and if the data 706 have indeed been decoded (for example, fully and without error), the burst 774 is not used by MT2, the data that it contains having already been received and decoded.

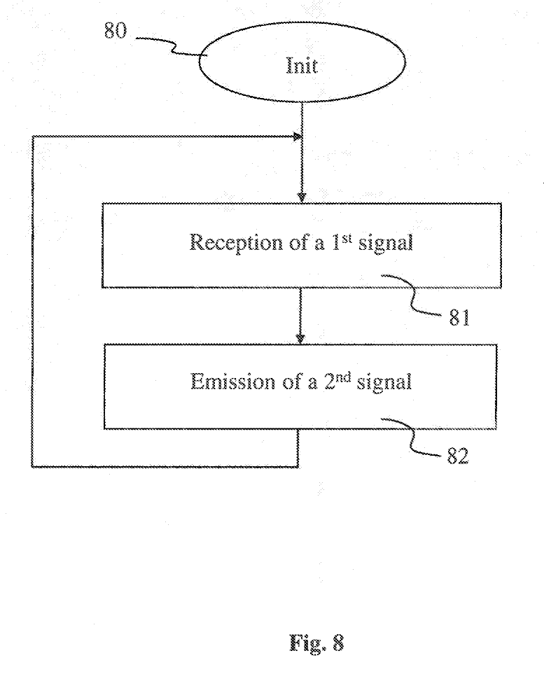

FIG. 8 shows a transmission method implemented by at least one relay station of the system 1 or 4, according to a non-restrictive particularly advantageous embodiment of the invention.

During an initialization step 80, the various parameters of the at least one relay station are updated. In particular, the parameters corresponding to the signals to be transmitted or received and to the corresponding sub-carriers are initialised in any manner (for example, following the reception of initialisation messages transmitted by one of the base stations, known as a master station or by a server not represented of system 1, or by operator commands),

Next, during a step 81, a first signal is received via a first wireless channel by the relay station RS 10, 40. The first signal is emitted by a base station BS1 11, 41 and this first signal is representative of data intended for at least one mobile terminal MT1 13 for the system 1, MT2 42 and/or MT3 43 for the system 4. According to one variant, the first signal received corresponds to a combination of signals emitted by each base station BS1 11, BS2 12 of a set of base stations BS1 and BS2. The signals emitted by all the base stations are each representative of the same data according to this variant and are emitted synchronously and at the same frequency. According to one variant, the first signal is emitted by a mobile terminal MT1 for the system 1, M12 or MT3 for the system 4 and the signal is representative of data intended for one or more base stations BS1, BS2.

Then during a step 82, the relay station RS 10, 40 emits a second signal via a second wireless channel. This second signal is representative of the data received with the reception of the, first signal, namely of the data intended for at least one receiver, i.e. for at least one mobile terminal or, according to one variant, for at least one base station. The second signal is emitted synchronously by RS with a third signal representative of the same data as those of the second signal, the third signal being intended to be emitted by at least one base station BS1, BS2. According to an advantageous variant, the third signal is emitted by the at least one base station BS1 having emitted the first signal. The synchronized emission of two signals representative of the same data by at least one base station and at least one relay station has the advantage that the received signal, corresponding to the combination in the air of the two emitted signals, will be received with more power as if it were emitted by a single station. Since the (relay and base) stations emit at the same frequency, the synchronized emission of the signals by two different stations enables the use of the channels to be optimized by using a single channel for the emission of the second and third signals. The first signal is decoded by the relay station RS to extract the data from it. The data thus decoded are then coded again by RS to be emitted by RS. The code used for the coding of the data in the first signal and for the coding of the same data in the second signal is advantageously the same. According to one variant, the codings used for the first signal and for the second signal are different, for example by the use of different spread codes in the case of a CDMA access.

During a step not shown on FIG. 8, the relay station RS receives at least one signal representative of synchronization information. This synchronization information is advantageously emitted by the at least one base station having emitted the first signal. According to one variant, the synchronization information is emitted by an element external to the network (for example by GPS (‘Global Positioning System’) satellite or by terrestrial broadcast station of a reference time). In this case, this synchronization is made externally to the radio frame. According to one variant, the synchronization information is hard-stored in a memory of the relay station. Advantageously, this synchronization is maintained via a very stable Crystal oscillator of the OCXO (Ovennized crystal Oscillator) type, and/or by an adjustment on the header signals from the BS.

Advantageously, the first signal is emitted over a first time slot and the second and third signals are emitted over a second time slot different from the first time slot. The first and second time slots advantageously belong to two temporally consecutive frames, for example the first slot belongs to a frame T and the second slot belongs to a frame T+1. According to one variant, the first and second time slots belong to the same temporal frame T.

Advantageously, the relay station has several antennas, a first antenna used to receive the first signal and a second antenna used to emit the second signal. The relay station switches from an antenna to another one to receive signals on the first antenna and emit, signals on the second antenna and conversely, i.e. to receive signals on the second, antenna and emit signals on the first antenna.

According to one variant, a fourth signal is emitted synchronously by the at least one base station BS1, BS2 and by the at least one relay station RS. This fourth signal corresponds for example to a synchronization preamble. The first frame emitted by the at least one base station comprises a signal representative of synchronization information to the relay station. This synchronization information is emitted in the frames following the first frame synchronously by the at least one base station and by the at least one relay station. According to one variant, a signal representative of an update of the synchronization information is regularly emitted by a base station or an external element to the at least one relay station.

According to one variant, the first signal is received by a plurality of relay stations (for example 2, 3 or 5 relay stations) forming a set of relay stations. The set of relay stations or a part only of the relay stations of this set then emits the data thus received, the combination in the air of the emitted signals forming the second signal. The use of several relay stations instead of one relay station makes it possible to use relay stations of lower power, generating less interference, and enables a given zone to be more finely covered,

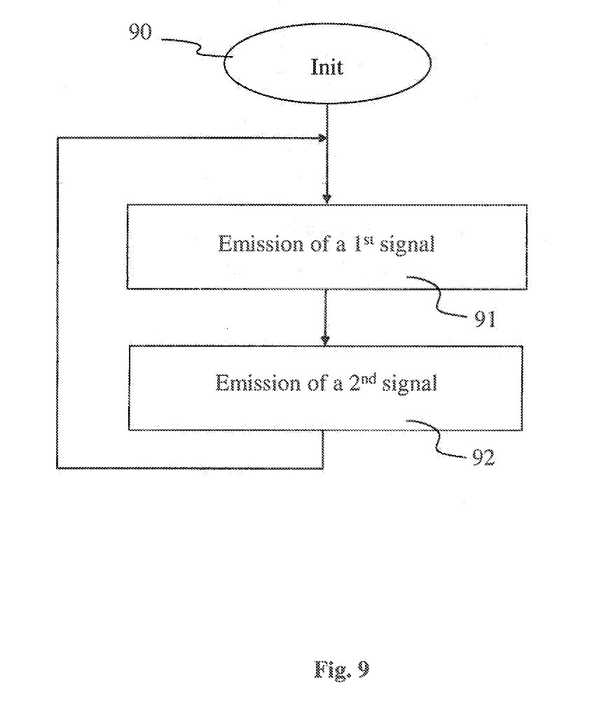

FIG. 9 shows a transmission method implemented in at least one base station of the system 1 or 4, according to a non-restrictive particularly advantageous embodiment of the invention. During an initialization step 90, the various parameters of the at least one base station are updated. In particular, the parameters corresponding to the signals to be transmitted or received and to the corresponding sub-carriers are initialised in any manner (for example, following the reception of initialisation messages transmitted by one of the base stations, known as a master station or by a server not represented of system 1, or by operator commands).

Then during a step 91, a first signal is emitted via a first wireless channel over a first time slot of a frame T. This first signal is emitted to a relay station RS and is representative of data intended for at least one mobile terminal MT1 to MT3.

Lastly, during a step 92, a third signal representative of the same data as those emitted in the first signal is emitted via a second wireless channel over a second time slot different from the first time slot, Advantageously, the first time slot belongs to a first frame T and the second time slot belongs to a consecutive frame T+1. According to one variant, the first and second time slots belong to the same frame. The third signal is emitted synchronously with a second signal intended to be emitted by the at least one relay station recipient of the first signal. Like the first signal and the third signal, the second signal is representative of the same data intended for at least one mobile terminal MT1 to MT3.

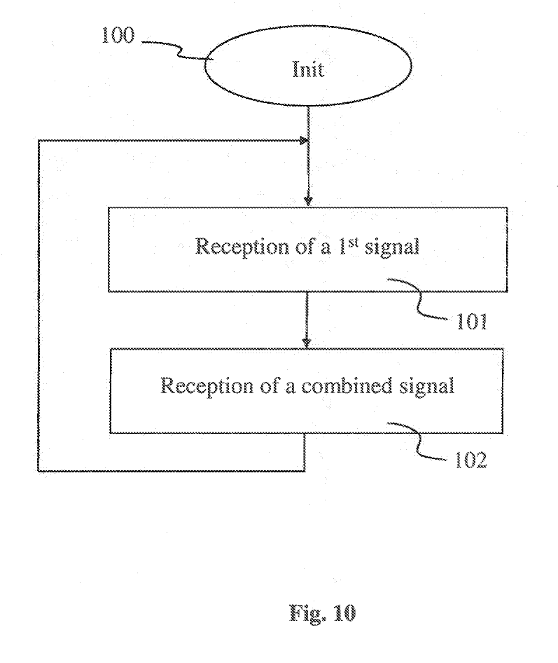

FIG. 10 shows a reception method implemented in at least one mobile terminal of the system 1 or 4, according to a non-restrictive particularly advantageous embodiment of the invention.

During an initialisation step 100, the different parameters of the mobile terminal are updated. In particular, the parameters corresponding to the signals to be transmitted or received and to the corresponding sub-carriers are initialised in any manner (for example, following the reception of initialisation messages transmitted by one of the base stations, known as a master station or by a server not represented of system 1, or by operator commands).

Then during a step 101, the at least one mobile terminal MT1 to MT3 receives a first signal representative of data intended for it via a first wireless channel over a first time slot.

Lastly, during a step 102, the at least one mobile terminal receives a combined signal over a second time slot different from the first one. The combined signal corresponds to the combination in the aft of several signals, at least a second and at least a third signal, representative of the same data, emitted at the same frequency and synchronously by at least one base station and at least one relay station.

Advantageously, the at least one mobile terminal selects, during a selection step not shown on FIG. 10, the signal that it decode among the received signals, i.e. among the first signal and the combined signal. Advantageously, the selection of the signal to be decoded is a function of at least a selection criterion belonging to the group comprising:
power of the signal received by the at least one mobile terminal: the signal received (or the burst received) with the best power level, the power level being estimated for each received signal according to any of the techniques known to those skilled in the art, is advantageously selected to be decoded. According to another variant, the received signal whose received power level is greater than a threshold value (for example −80 dBm) is selected to be decoded. The account taken of this criterion offers notably the advantage of only decoding the best of the received signals;
link quality between at least a BS or RS station and the at least one mobile terminal: the quality of the link between a station and the mobile terminal is for example estimated by determining the signal-to-noise ratio (SNR). Advantageously, the link having the highest SNR is selected so that the signal emitted via this link is decoded. According to one variant, the link whose SNR is greater than a threshold value (for example 10 dB or 20 dB) is selected so that the signal emitted via this link is decoded. The account taken of this criterion offers notably the advantage of only decoding the signal received in a sufficiently audible manner to be able to process it; and
a received signal error rate (BER or Bit Error Rate), FER (‘Frame Error Rate’): the received signals are decoded and the BER or FER is estimated according to any of the techniques known by a person skilled in the art for each of the decoded signals, the data from the signal having the lowest error rate being retained. The account taken of this criterion has the advantage of comparing the decoded data from each of the signals and of using the one having the best error rate in order to for example apply to it any of the methods known by a person skilled in the art to make up for the errors at a lower cost.

According to an advantageous variant, the at least one mobile terminal adapts the receiving gain during a gain adaptation step not shown on FIG. 10 according to a parameter belonging to the following group:
a received signal position in a communication frame: from the information contained in the frame header, the mobile terminal knows which position is occupied by the burst emitted, by the base station to the relay station and containing the data intended for it, called first burst, and which position is occupied by the burst emitted by the relay station to it and corresponding to the retransmission of data intended for it received from the base station, called second burst. During the reception of the first burst, the at least one mobile terminal determines for example the signal power and adapts its receiving gain for the reception of the second burst, the second burst being in all probability received with a greater power than the first burst, the second burst being emitted synchronously by the base station and the relay station. The gain adaptation is advantageously made according to a formula determined empirically; and
information representative of a signal transmitter contained for example in the frame header: according to which station emits the signal (base station or relay station), the at least one mobile terminal parameterizes its receiving gain.
   The gain adaptation enables the mobile terminal to optimize the reception of the received signals and thus to minimize reception errors.

Naturally, the invention is not limited to the embodiments previously described.

In particular, the invention is not limited to a system comprising one or two base stations, a relay station and one or three mobile terminals but also extends to a system comprising more than three base stations, more than two relay stations, two terminals or more.

According to one variant, the assignment of one or more (base or relay) stations to a given mobile terminal changes over time according for example to the displacement of the mobile terminal. According to one variant, the assignment of stations to a mobile terminal is made according to the reception offsets corresponding to each station estimated from a first signal emitted by a mobile terminal, for example when the mobile terminal wants to enter the network. The stations whose first signal reception offset is lower than a determined threshold value are advantageously assigned to the mobile terminal.

1. Transmission method for a wireless network, said network comprising a plurality of stations transmitting at the same frequency, wherein it comprises the following steps implemented by at least one relay station of said plurality of stations:
reception via a first wireless channel of a first signal representative of data, said first signal being emitted synchronously by at least two base stations of said plurality of stations; and
emission via a second wireless channel of a second signal representative of said received data to a set comprising at least one receiver,
said second signal being emitted synchronously with a third signal representative of said data and intended to be emitted by at least a base station of said plurality of stations.

2. Method according to claim 1, wherein said third signal and said first signal are emitted by at least two same base stations.

3. Method according to claim 1, wherein it comprises a step for the reception of at least a signal representative of synchronization information.

4. Method according to claim 3, wherein the at least one signal representative of synchronization information is emitted by the at least one of the two stations having emitted said first signal.

5. Method according to claim 1, wherein the first signal is emitted over a first time slot, the second and third signals are emitted over a second time slot, said first and second time slots belonging to a same communication frame.

6. Method according to claim 1, wherein the first signal is emitted over a first time slot, the second and third signals are emitted over a second time slot, said first and second time slots belonging to two consecutive communication frames.

7. Method according to claim 1, wherein said at least one relay station receives said first signal via at least a first antenna and emits said second signal via at least a second antenna.

8. Method according to claim 1, wherein the same fourth signal is emitted by the at least one base station and by the at least one relay station synchronously.

9. Transmission method for a wireless network, said network comprising a plurality of stations emitting at the same frequency, wherein it comprises the following steps:
emission, in a synchronized manner by at least two base stations of said plurality of stations, via a first wireless channel of a first signal representative of data over a first time slot, and
emission via a second wireless channel of a third signal representative of said data over a second time slot,
said third signal being emitted synchronously by at least a base station of said plurality of stations with a second signal representative of said data and intended to be emitted by at least a relay station of said plurality of stations recipient of the first emitted signal.

10. Reception method for a wireless network, said network comprising a plurality of stations emitting at the same frequency and at least one mobile terminal, wherein it comprises the following steps implemented by the at least one mobile terminal:
reception via a first wireless channel of a first signal representative of data over a first time slot, said first signal being emitted synchronously by at least two base stations of said plurality of stations, and
reception of a combined signal over a second time slot, said combined signal comprising a second signal representative of said data and a third signal representative of said data,
said second and third signals being emitted synchronously by respectively at least one base station of said plurality of stations and at least one relay station of said plurality of stations.

11. Method according to claim 10, wherein it comprises a step for the selection of said received signals according to at least a selection criterion belonging to the group comprising:
a received signal power,
a link quality between at least one transmitting station and the receiver,
a received signal error rate.

12. Method according to claim 9, wherein it comprises a gain adaptation step according to a parameter belonging to the group comprising:
a received signal position in a communication frame,
information representative of the transmitter of a signal.

13. Wireless relay device, wherein it comprises:
a receiver for receiving a first signal representative of data via a first wireless channel, said first signal being emitted synchronously by at least two base stations of a plurality of base stations of a wireless network emitting at the same frequency, and
a transmitter for emitting a second signal representative of said data received to a set comprising at least a receiver via a second wireless channel,
said second signal being emitted synchronously with a third signal representative of said data and intended to be emitted by at least a base station of said plurality of base stations.

14. System for wireless communication comprising a plurality of base stations and at least one relay station, the plurality of base stations and the at least one relay station emitting at the same frequency, wherein that at least two base stations of said plurality each comprise a transmitter for the synchronized emission via a first wireless channel of a first signal representative of data, the at least one relay station being configured to receive at least one of the first signals emitted by the at least two base stations, the relay station comprising a transmitter for the sending of a second signal representative of said data synchronously with a third signal representative of said data emitted by at least a base station of said plurality of base stations.
